(19) United States
(12) Patent Application Publication
(10) Pub. No.: US 2004/0207198 A1
(43) Pub. Date: Oct. 21, 2004

(54) Pipe system for underwater installations with expansion-compensating bellows

(76) Inventors: Patrice Aguilera, Hvalstad (NO); Helge Ingebretsen, Svelvik (NO)

Correspondence Address: ROTHWELL, FIGG, ERNST & MANBECK, P.C., 1425 K STREET, N.W., SUITE 800, WASHINGTON, DC, 20005, US

(21) Appl. No.: 10/488,006

(22) PCT Filed: Aug. 19, 2002
(86) PCT No.: PCT/NO02/00280

(30) Foreign Application Priority Data
Aug. 29, 2001 (NO) 2001.4189

(51) Int. Cl. F16L 39/00

(52) U.S. Cl. 285/125.1; 285/226

(57) ABSTRACT

Pipe system for subsea installations for offshore production or processing of hydrocarbons, for interconnection of or internal connections in functional units, such as Xmas trees (1) and manifold modules (2), where a pipe connection comprises communicating pipe branches (5,7,8) which run with mutual angle deviation or parallel to each other. A pipe branch (5) is provided with a bellows device (11) for obtaining a certain possibility of movement of the pipe branch, and a second pipe branch (7) is also provided with bellows device (12) for obtaining a certain possibility of movement of the second pipe branch (7).

### BACKGROUND

This invention relates to a pipe system for subsea installations for offshore production or processing of hydrocarbons, for interconnection of or internal connections in functional units, such as Xmas trees and manifold modules, where a pipe connection comprises communicating pipe branches which run with mutual angle deviation or parallel to each other.

It is here a matter of quite complicated constructions and installations with comprehensive pipe systems which can have pipe branches in various directions and with various geometrical shapes. There are stringent requirements for reliability and operational safety of such subsea installations, inter alia in view of the water depths in question, and also the special pressure and temperature conditions which can occur. The sea floor installation itself with the assembly of functional units and the establishment of pipe connections also represents big challenges concerning the design of the included pipe systems.

In previously known subsea installations of the type being of interest here, there has been used large and space demanding pipe loops for interconnecting units at the installation, possibly also for internal connections belonging to one and the same functional unit. The purpose of such pipe loops is to make possible certain small, but often unavoidable movements in the constructions. This can be due to temperature extension or other conditions. Also during assembling it can be highly desirable with some extent of movability in order to join units or parts which will be included in the whole subsea installation. The large pipe loops so far used are not only inconveniently space demanding, but also involve a considerable increase in weight of the whole installation. This is obviously a big disadvantage.

The invention is to an essential degree based on use of bellows or expansion devices which can be of known and commercially available types. Conventional use of bellows devices in subsea pipelines is known from Norwegian Patent No. 156.342, British Patent No. 1.495.216 and U.S. Pat. No. 4,718,459. In these previously known applications the conditions are considerably simpler and more near at hand for use of expansion elements than in complicated subsea installations of the kind described above. It is, among other things, a question of the number of degrees of freedom which the mentioned movability of the pipe systems should have.

One purpose of the invention is mainly to provide an improved pipe system for subsea installations as stated in the introduction above, where considering the mentioned conditions and problems, a considerable saving of volume and weight is attained at the same time as the installations will have the required reliability and operational safety.

### SUMMARY

The new and characteristic of the pipe system according to the invention is in the first place that a pipe branch is provided with a bellows device for obtaining a certain possibility of movement of the pipe branch, and that a second pipe branch is also provided with bellows device for obtaining a certain possibility of movement of the second pipe branch.

The invention will be further explained below with reference to the drawings which show some exemplary embodiments based on the invention.

### DESCRIPTION OF THE DRAWINGS

FIG. 1 shows a section of a pipe system in a bridge-like configuration in connection with one or several functional units, such as a choke module,

FIG. 2 shows in perspective a manifold unit with appurtenant pipe systems, whereof a section is indicated by a circle 2A, which is also shown in enlarged form in FIG. 2A,

FIG. 2A shows an enlarged section from FIG. 2 with a pipe system comprising several pipe connections, and

FIG. 3 shows a part of a pipe system in relation to a Xmas tree.

### DETAILED DESCRIPTION

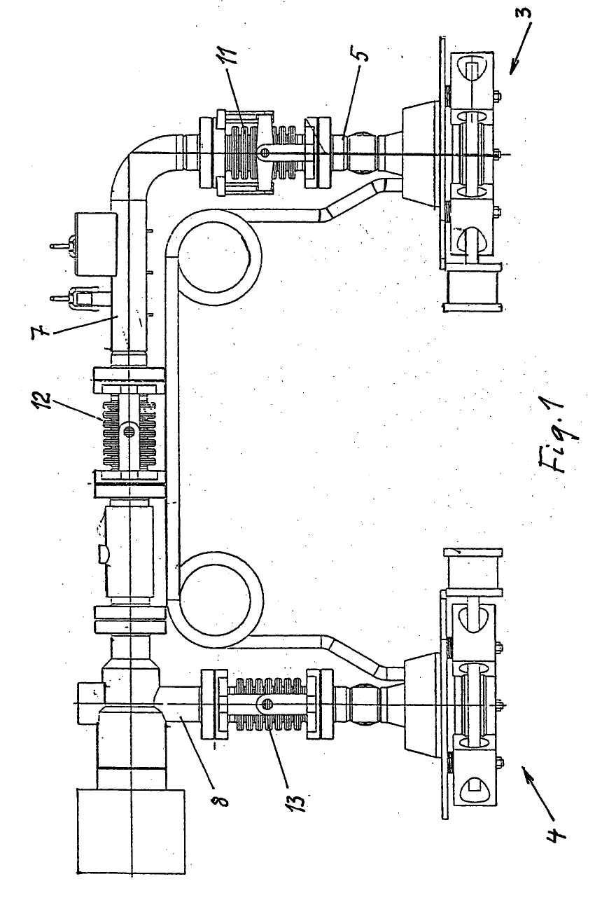

The pipe system, shown in elevation in FIG. 1, provides for connection between two functional units 3 and 4. In relation to the functional units two vertical pipe branches 5 and 8 are arranged, both of them communicating with a horizontal branch 7. Each of the three pipe branches of the shown pipe connection comprises a bellows device, namely the pipe branch 5 with the bellows device 11, the pipe branch 7 with the bellows device 12 and the pipe branch 8 with the bellows device 13. With such arrangement a desired and sufficient degree of flexibility will be present during installation and operation of the pipe system, in particular when temperature variations occur, based on use of bellows constructions which can be of a per se known and commercially available types.

In the example shown in FIG. 1 according to the circumstances it could be sufficient with two of the three bellows devices shown, preferentially with the two bellows arranged in pipe branches forming an angle with each other.

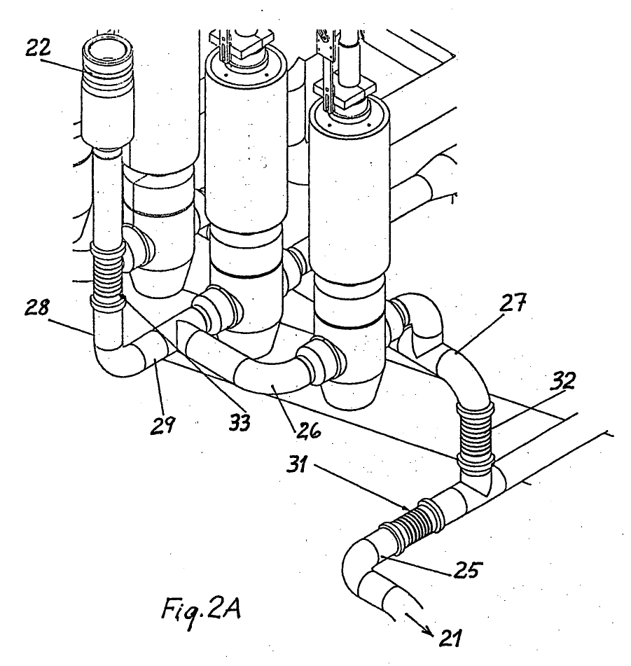

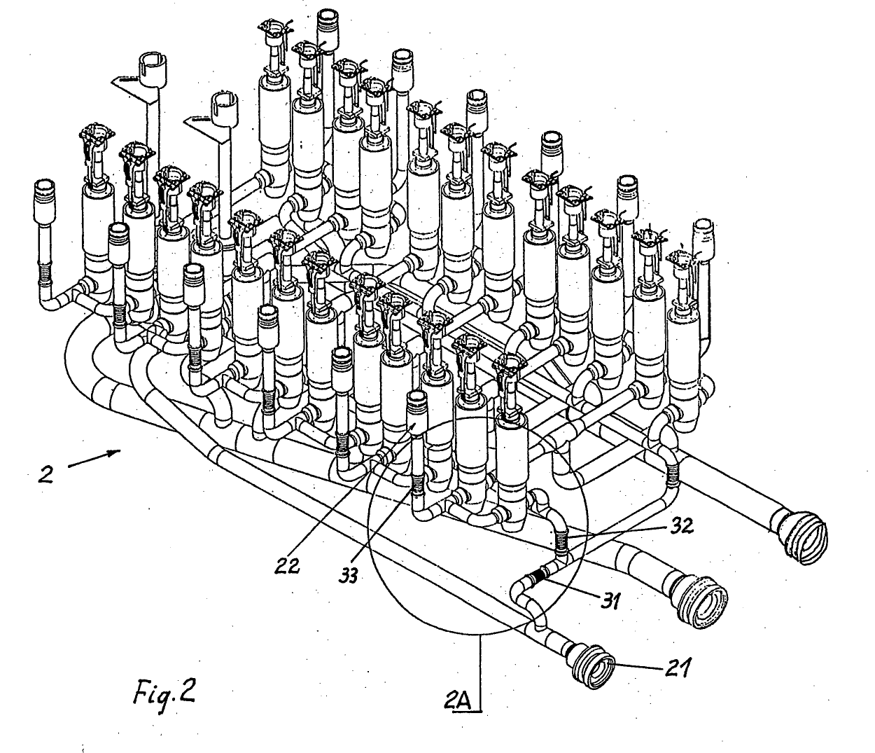

The manifold unit shown in FIG. 2 is based mainly on common construction principles, but the pipe system according to the invention is provided with bellows devices, e.g. the devices 31, 32 and 33 within the segment 2A in this figure. These bellows devices are arranged in a part of the pipe system forming a connection between a test pipe 21 and a connector or mandrel 22. As more clearly shown in FIG. 2A the pipe connection concerned comprises communicating pipe branches 25, 27, 26, 29 and 28. It is evident from FIG. 2A that the pipe branches can be formed of more or less straight pipe lengths and associated bends. A bellows 31 is placed within the pipe branch 25, a second bellows 32 within the branch 27 and a third bellows 33 within the branch 28. Compared with the pipe connection in FIG. 1, where the three pipe branches can be considered to lie more or less in the same vertical plane, the configuration in FIG. 2A is more complicated as the pipe branches lie in many planes, however in such a way that the straight pipe parts are mainly either horizontal or vertical. This applies as well to the pipe branches provided with the bellows 31, 32 and 33.

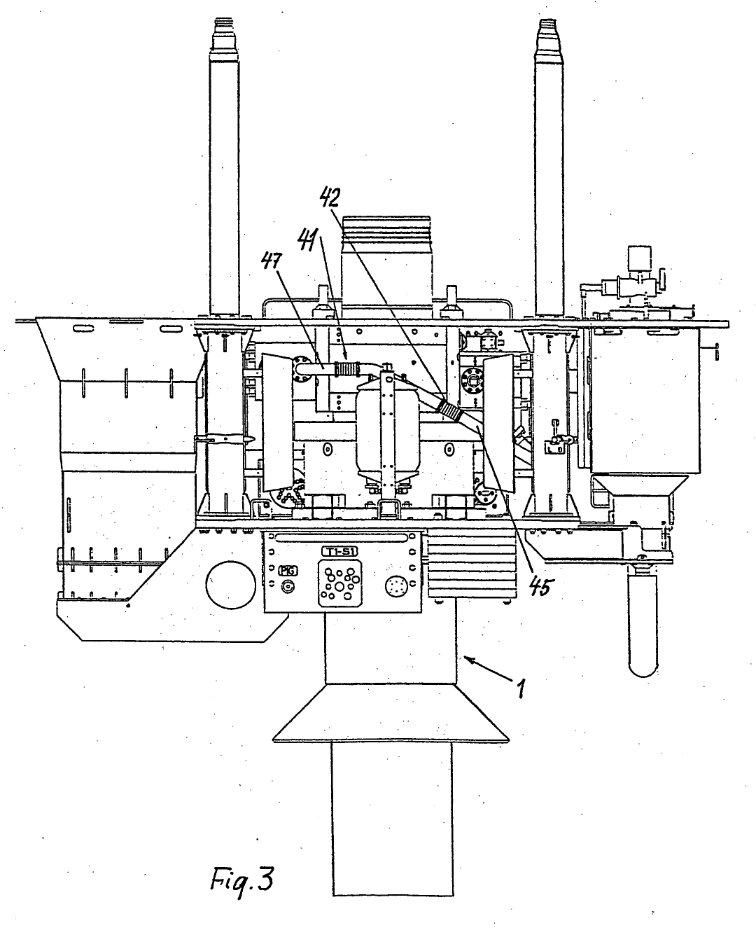

Finally FIG. 3 shows an example of a pipe connection in association with a Xmas tree 1. Two pipe branches 45 and 47 form an angle with each other considerably smaller than 90 degrees. The pipe branch 45 is provided with a bellows device 41 and the pipe branch 47 has a bellows device 42. Also with such a course of the pipe connection, with the shown angle between the pipe branches 45 and 47, the bellows 41 and 42 will have the desired effect as mentioned in the introduction above.

1. Pipe system for subsea installations for offshore production or processing of hydrocarbons, for interconnection of or internal connections in functional units, such as Xmas trees and manifold modules, where a pipe connection comprises communicating pipe branches which have circular cross-section and run with mutual angle deviation or parallel to each other, characterized in that a pipe branch is provided with a bellows device for permitting movement of the pipe branch, and that a second pipe branch is also provided with bellows device for permitting movement of the second pipe branch.

2. Pipe system according to claim 1, wherein two pipe branches each provided with its bellows device, have a substantially right angle in relation to each other.

3. Pipe system according to claim 1 wherein two pipe branches, each provided with its bellows device, are mainly parallel in relation to each other.

4. Pipe system according to claim 1, wherein at least one pipe branch, provided with a bellows device, is vertical with connection to a functional unit.

5. Pipe system according to claim 1, wherein three pipe branches, each provided with its bellows device, form a bridge-like configuration with two substantially vertical pipe branches and an intermediate, substantially horizontal pipe branch.
